(19) United States
(12) Patent Application Publication
(10) Pub. No.: US 2013/0055187 A1
(43) Pub. Date: Feb. 28, 2013

(54) FLOORPLAN CREATION INFORMATION GENERATING METHOD, FLOORPLAN CREATION INFORMATION GENERATING PROGRAM, FLOORPLAN CREATION INFORMATION GENERATING DEVICE, FLOORPLAN OPTIMIZING METHOD, FLOORPLAN OPTIMIZING PROGRAM, AND FLOORPLAN OPTIMIZING DEVICE

(71) Applicant: Yoshihito Hiromitsu, Kanagawa (JP)

(72) Inventor: Yoshihito Hiromitsu, Kanagawa (JP)

(73) Assignee: Renesas Electronics Corporation, Kawasaki-shi (JP)

(21) Appl. No.: 13/590,959

(22) Filed: Aug. 21, 2012

(30) Foreign Application Priority Data
Aug. 25, 2011 (JP) 2011-183285

(51) Int. Cl. G06F 17/50

(52) U.S. Cl. 716/122

(57) ABSTRACT

A floorplan creation information generating method according to this embodiment includes setting a group to a plurality of circuit modules based on a netlist and group setting information, calculating a distance that satisfies a timing constraint between the set groups, and generating floorplan creation information for creating a floorplan including the calculated distance between the groups.

### CROSS-REFERENCE TO RELATED APPLICATIONS

This application is based upon and claims the benefit of priority from Japanese patent application No. 2011-183285, filed on Aug. 25, 2011, the disclosure of which is incorporated herein in its entirety by reference.

### BACKGROUND

The present invention relates to a floorplan creation information generating method, a floorplan creation information generating program, a floorplan creation information generating device, a floorplan optimizing method, a floorplan optimizing program, and a floorplan optimizing device. In particular, the present invention relates to a floorplan creation information generating method, a floorplan creation information generating program, a floorplan creation information generating device, a floorplan optimizing method, a floorplan optimizing program, and a floorplan optimizing device for creating a floorplan based on a plurality of groups including a circuit module.

In recent years, an increase in the size of the Large Scale Integrated (LSI) circuits has been advanced and higher performance such as an operation on high frequencies has been requested as well. Therefore, difficulty in the design of the semiconductor integrated circuit increases and the design period tends to further increase. On the other hand, the period since determination of product requirements specification of the semiconductor integrated circuit till product shipment that is requested by customers tends to be shorter, thus there is a strong request for a reduction in the design period.

In the design of the semiconductor integrated circuit, individual functional modules (also referred to as a logic module and a circuit module) are designed in a circuit design process, then a floorplan for determining placement of the functional modules is created in a layout design process, and circuits included in the functional modules are placed and routed according to the floorplan.

For example, Japanese Unexamined Patent Application Publication No. 2009-9598 is known as a related art for creating the floorplan of the semiconductor integrated circuit.

FIG. 18 shows a configuration of a floorplan creating device according to the related art disclosed in Japanese Unexamined Patent Application Publication No. 2009-9598. As shown in the drawing, a floor creating device 930 of the related art includes a floorplan creating unit 921 for creating a floorplan, a floorplan evaluating unit 920 for evaluating the created floorplan, and a floorplan correcting unit 922 for correcting the floorplan based on the evaluation of the floorplan.

Moreover, the floorplan evaluating unit 920 includes an element of interest extracting unit 902 for extracting an element of interest from the floorplan, an individual evaluation value calculating unit 903 for calculating an individual evaluation value that evaluates the extracted element individually, a total evaluation value calculating unit 904 for calculating a total evaluation value based on the calculated individual evaluation value, a storage unit 911 for storing the individual evaluation value and the total evaluation value, and a correcting item selecting unit 912 for selecting an item to be corrected based on the individual evaluation value and the total evaluation value.

FIG. 19 shows a floorplan creating method according to the related art disclosed in Japanese Unexamined Patent Application Publication No. 2009-9598. As shown in the drawing, in the floorplan creating method according to the related art, firstly the floorplan creating unit 921 creates data for the floorplan (S901).

Next, the element of interest extracting unit 902 extracts placement information, connection information, and group information from the created data of the floorplan as the elements of interest (S902).

Next, the individual evaluation value calculating unit 903 calculates each of the individual evaluation values based on the placement information, the connection information, and the group information for the data regarding the extracted elements of interest with a line length of a virtual line, the number of intersections between the virtual lines, a logic module relationship, a hard macrocell relationship, and an area of a group region as the individual evaluation items (S903).

Next, the total evaluation value calculating unit 904 adds the calculated individual evaluation values, which are the line length of the virtual line, the number of intersections of the virtual lines, the logic module relationship, the hard macrocell relationship, and the area of the group region, so as to calculate the total evaluation value regarding the floorplan to be evaluated (S904).

Next, the storage unit 911 registers the individual evaluation values calculated in S903 and the total evaluation value calculated in S904 to a database (S905).

Next, the correcting item selecting unit 912 selects one or more individual evaluation items that should be corrected from the stored individual evaluation values (S906).

Then, the correcting item selecting unit 912 evaluates whether or not the floorplan needs a correction regarding the selected individual evaluation item (S907). As evaluation conditions, a maximum repetition number of the correction and a maximum value of required time taken for the correction operation are set in advance. When a current number of repetition and required time do not reach the maximum value, it is evaluated that the floorplan needs a correction.

In S907, when the floorplan needs a correction, the floorplan correcting unit 922 corrects the floorplan (S908).

As described above, in Japanese Unexamined Patent Application Publication No. 2009-9598, the elements of interest are extracted from the floorplan in S902, the individual evaluation values are obtained in S903, and the total evaluation value is calculated in S904. Then, a plurality of floorplans are relatively evaluated by comparing the total evaluation values, which are obtained by executing S902 to 904 for the plurality of floorplans. Therefore, it is not necessary to perform detailed placing and routing for the evaluation of the floorplan and possible to quantitatively evaluate the created floorplan itself by the total evaluation value.

### SUMMARY

As mentioned above, the floorplan creating method according to the related art disclosed in Japanese Unexamined Patent Application Publication No. 2009-9598 creates the floorplan and evaluates the created floorplan by the individual evaluation values and the total evaluation value, and thus enabling efficient correction of the floorplan.

However, the present inventor has found a problem that in the floorplan creating method according to the related art, after the floorplan is created by the method of FIG. 19, the floorplan must be corrected again, and the floorplan may be repeatedly created. Note that returning to the floorplan creation process after the floorplan creation process and repeating the floorplan creation is referred to as an iteration.

Generally when a semiconductor integrated circuit is placed on a semiconductor chip, a floorplan is created, an automatic placement tool performs temporary placement and routing, timing verification is performed, and when a timing violation between the logical modules placed according to the floorplan is turned out to be caused from the placement, the process is repeated by manually returning to the floorplan step and correcting the floorplan.

That is, even when the floorplan is created by the floorplan creating method according to the related art, in the case that temporary placement and routing is performed according to the floorplan and timing is confirmed in order to determine the floorplan, a timing violation may occur due to the floorplan. In particular, as the timing between the functional modules is not considered in the floorplan creating method according to the related art in FIG. 19, the timing violation may occur. Then, the floorplan must be corrected again, and thus resulting in the repetition of the floorplan creation.

Accordingly, there has been a problem in the floorplan creating method according to the related art that the floorplan is repeatedly created and the iteration is generated, and this leads to an increase in the design period.

The present invention is characterized in that groups are set to a plurality of circuit modules, a distance that satisfies a timing constraint between the set groups is calculated, and floorplan creation information for creating a floorplan including the calculated distance between the groups is generated.

The present invention generates the floorplan creation information for creating the floorplan based on the distance that satisfies the timing constraint between the groups. Thus it is possible to create the floorplan using the floorplan creation information that does not cause a timing violation, prevent the iteration in the floorplan design, thereby shortening the design period.

The present invention can provide a floorplan creation information generating method, a floorplan creation information generating program, a floorplan creation information generating device, a floorplan optimizing method, a floorplan optimizing program, and a floorplan optimizing device that can prevent the iteration in the floorplan design and reduce the design period.

### BRIEF DESCRIPTION OF THE DRAWINGS

The above and other aspects, advantages and features will be more apparent from the following description of certain embodiments taken in conjunction with the accompanying drawings, in which:

FIG. 1 shows a functional configuration of a floorplan creation information generating device according to a first embodiment of the present invention;

FIG. 2 shows a hardware configuration of the floorplan creation information generating device according to the first embodiment of the present invention;

FIG. 3 is a flowchart showing a flow of a floorplan creation generating method according to the first embodiment of the present invention;

FIGS. 4A and 4B explain group setting information to be processed by the floorplan creation generating method according to the first embodiment of the present invention;

FIGS. 5A to 5D explain an operation of the floorplan creation information generating method according to the first embodiment of the present invention;

FIG. 6 explains an operation of the floorplan creation information generating method according to the first embodiment of the present invention;

FIG. 7 explains the floorplan creation information to be processed by the floorplan creation generating method according to the first embodiment of the present invention;

FIG. 8 shows a functional configuration of a floorplan optimizing device according to a second embodiment of the present invention;

FIG. 9 is a flowchart showing a flow of a floorplan optimizing method according to the second embodiment of the present invention;

FIG. 10 is a flowchart showing a flow of a reference example of the floorplan optimizing method;

FIG. 11 is an image diagram of an example 1 for a floorplan according to the reference example;

FIG. 12 is an image diagram of the example 1 for a floorplan according to the second embodiment of the present invention;

FIG. 13 is an image diagram of an example 2 for the floorplan according to the reference example;

FIG. 14 is an image diagram of the example 2 for the floorplan according to the second embodiment of the present invention;

FIG. 15 is an image diagram of the example 2 for the floorplan according to the second embodiment of the present invention;

FIG. 16 is an image diagram of an example 3 for the floorplan according to the reference example;

FIG. 17 is an image diagram of the example 3 for the floorplan according to the second embodiment of the present invention;

FIG. 18 shows a functional configuration of a floorplan creation device according to a related art; and

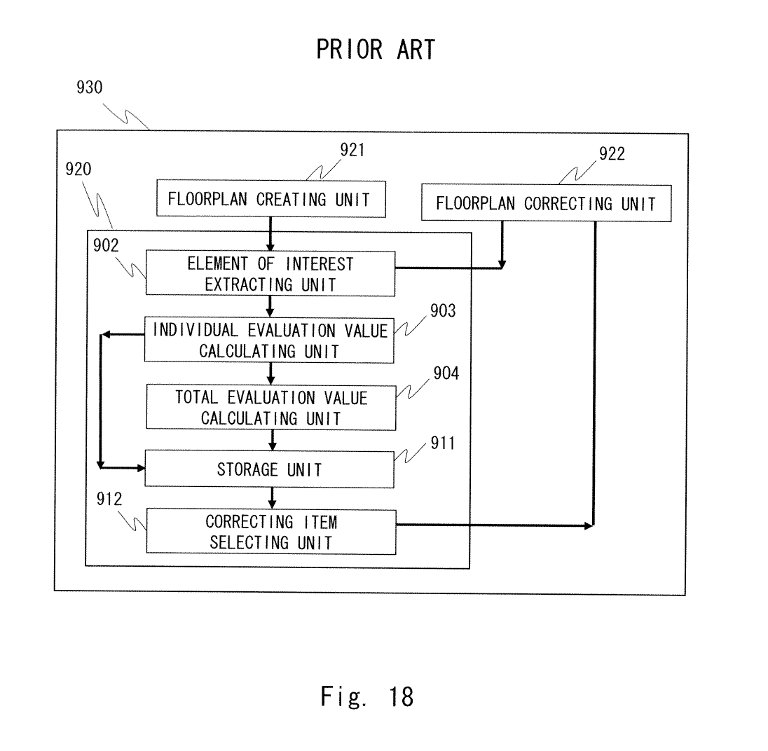

FIG. 19 is a flowchart showing a flow of a floorplan creating method according to the related art.

### DETAILED DESCRIPTION

### First Embodiment

Hereinafter, a first embodiment of the present invention is explained with reference to the drawings.

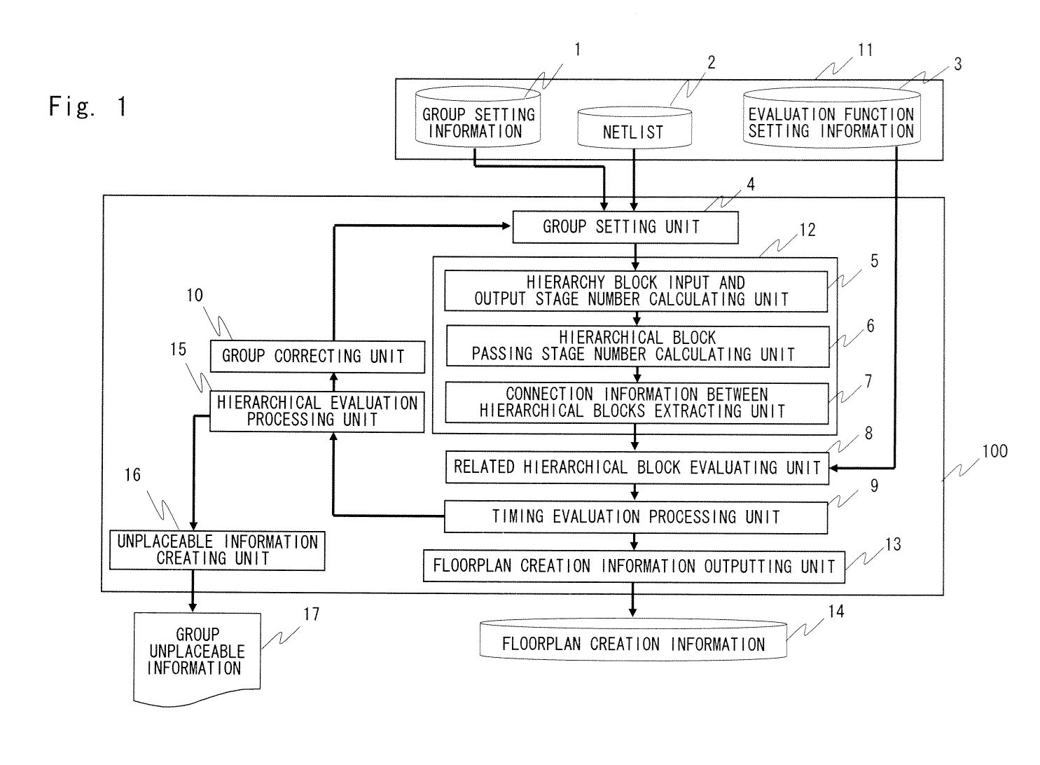

FIG. 1 shows a functional configuration of a floorplan creation information generating device according to the first embodiment of the present invention. A floorplan creation information generating device 100 is a design device for a floorplan creation process in the case of providing a layout design of a semiconductor integrated circuit using a group of netlists having a hierarchical structure.

The floorplan creation information generating device 100 outputs floorplan creation information 14 and group unplaceable information 17 based on an input file group 11.

The input file group 11 includes group setting information 1, a netlist 2, and evaluation function setting information 3. The net list 2 is circuit information that defines a configuration and a connection relationship of functional modules (circuit modules) that are placed and routed on the semiconductor integrated circuit, and especially, a netlist having the hierarchical structure here. The group setting information 1 specifies a group to the functional module in the netlist 2 having the hierarchical structure. The evaluation function setting information 3 includes a gate delay value and a distance delay value and cycle information. Hereinafter, the gate delay value (cell delay value) is a delay value per gate stage, the distance delay value is a delay value for a unit wiring length (distance), and the cycle information is an operating cycle (frequency) of circuit.

The floorplan creation information generating device 100 includes a group setting unit 4, a circuit information extracting unit 12, a related hierarchical block evaluating unit 8, a timing evaluation processing unit 9, a hierarchical evaluation processing unit 15, a group correcting unit 10, and an unplaceable information creating unit 16.

The group setting unit 4 receives the netlist 2 and the group setting information 1 of the input file group 11 and sets the group to the functional module of the netlist 2. In this embodiment, a hierarchy of the netlist 2 is selected and the group is set to the functional module (hierarchical block). For example, information indicating the group set to the hierarchical block (for example, hierarchical block information) is generated for the selected hierarchical level.

The circuit information extracting unit 12 and the related hierarchical block evaluating unit 8 are distance calculating units that calculate a distance satisfying a timing constraint between the set groups. For example, the circuit information extracting unit 12 and the related hierarchical block evaluating unit 8 refer to the information indicating the set group and calculate the distance that satisfies the timing constraint for a path connecting a plurality of hierarchical blocks (functional modules).

The circuit information extracting unit 12 is a circuit stage number calculating unit that calculates the number of stages in a circuit of the set group. For example, the circuit information extracting unit 12 refers to the information indicating the set group and extracts the number of circuit stages, which is the number of stages in the delay circuit (gate circuit) for all input and output paths in the plurality of hierarchical blocks (functional modules).

The circuit information extracting unit 12 includes a hierarchical block input and output stage number calculating unit 5, a hierarchical block passing stage number calculating unit 6, and a connection information between hierarchical blocks extracting unit 7.

For each hierarchical block with the set group, the hierarchical block input and output stage number calculating unit 5 calculates, in the hierarchical block including a sequential cell (or a flip-flop) to be a starting point or an ending point from the netlist 2, the number of logic element stages (the number of hierarchical block output stages) from the sequential cell to an output terminal of the hierarchical block and calculates the number of logic element stages (the number of hierarchical block input stages) from an input terminal of the hierarchical block to the sequential cell.

For each hierarchical block with the set group, when there is a path passing through the hierarchical block, the hierarchical block passing stage number calculating unit 6 calculates the number of logic element stages (the number of hierarchical block passing stages) that pass from the input terminal of the hierarchical block to the output terminal of the hierarchical block via a combining circuit. The hierarchical block passing stage number calculating unit 6 extracts the path from the sequential cell to the sequential cell and calculates the number of stages passing through the hierarchical block and not through the sequential cell.

The connection information between hierarchical blocks extracting unit 7 calculates the number of logic element stages between the hierarchical blocks (connection information between the hierarchical blocks) for each hierarchical block with the set group. The connection information between hierarchical blocks extracting unit 7 extracts the path from the sequential cell to the sequential cell and calculates the number of stages from the hierarchical block to another hierarchical block.

The related hierarchical block evaluating unit 8 receives the number of hierarchical block output stages, the number of hierarchical block input stages, the number of passing hierarchical blocks, the connection information between the hierarchical blocks extracted by the circuit information extracting unit 12, and the evaluation function setting information 3 of the input file group 11 and calculates the distance between each hierarchical block that satisfies the timing constraint.

The timing evaluation processing unit 9 evaluates whether the timing between hierarchical blocks is satisfied based on the distance calculated by the related hierarchical block evaluating unit 8.

When the timing evaluation processing unit 9 evaluates that the timing between each hierarchical block cannot be satisfied, the hierarchical evaluation processing unit 15 evaluates whether there is a lower hierarchy of the hierarchical block specified by the group setting information 1.

When the hierarchical evaluation processing unit 15 evaluates that the hierarchical block is not the bottom hierarchy, which means that there is the lower hierarchy, the group correcting unit 10 selects the lower hierarchy based on the group setting information 1 and sets the group to the hierarchical block at the selected hierarchy.

When the hierarchical evaluation processing unit 15 evaluates that the hierarchical block is the bottom hierarchy, which means that there is no lower hierarchy, the unplaceable information creating unit 16 outputs the group unplaceable information 17 and ends the process.

When the timing evaluation processing unit 9 evaluates that the timing between each hierarchical blocks is satisfied, the floorplan creation information outputting unit (floorplan creation information generating unit) 13 generates and outputs the floorplan creation information 14, which is distance information between the groups.

For example, firstly the floorplan creation information outputting unit 13 preferentially extracts a smaller distance as the floorplan creation information 14, from the distances that satisfies the timing between the hierarchical blocks and also the distances for the paths not passing through the sequential cell in the hierarchical block. Then, the floorplan creation information outputting unit 13 preferentially extracts a smaller distance as the floorplan creation information 14, from the distances that satisfy the timing between the hierarchical blocks and also the distances for the paths passing through the sequential cell in the hierarchical block.

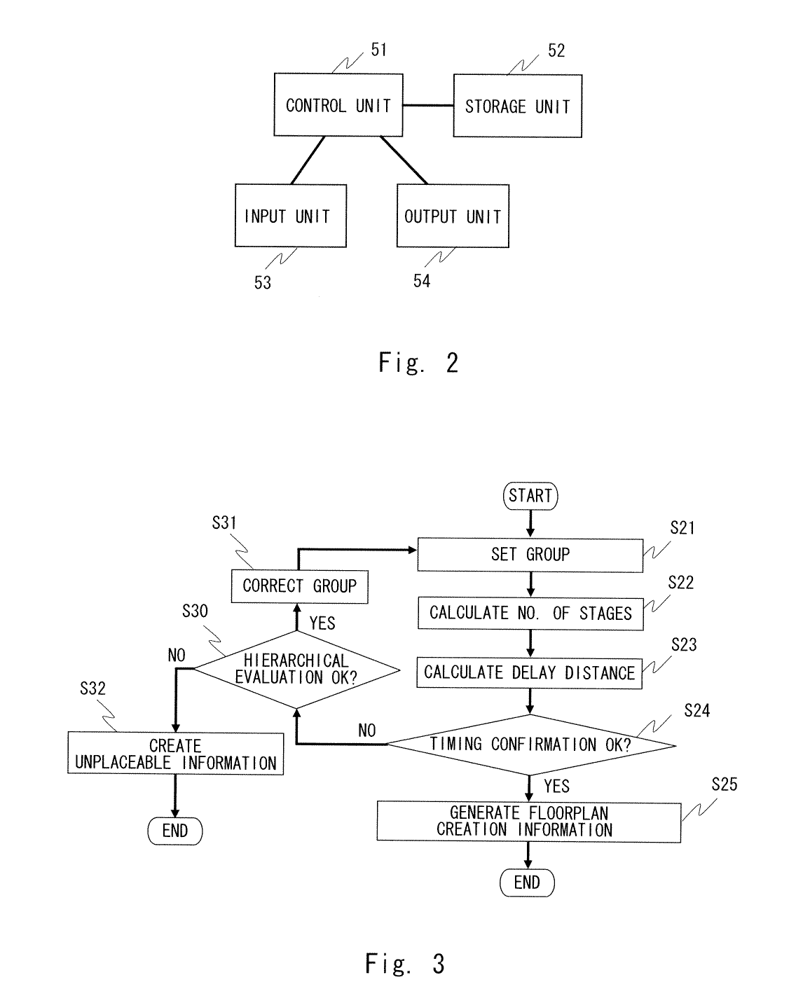

FIG. 2 shows a hardware configuration of the floorplan creation information generating device according to the first embodiment of the present invention. The floorplan creation information generating device 100 is composed of an information processing device such as a personal computer and a workstation. Executing a program on the information processing device realizes each function of the floorplan creation information generating device 100 and each process of the floorplan creation information generating method.

The floorplan creation information generating device 100 includes a control unit 51, a storage unit 52, an input unit 53, and an output unit 54. Note that the control unit 51, the storage unit 52, the input unit 53, and the output unit 54 may all be formed of one hardware device or may be formed of several hardware devices. Moreover, those components may be connected via a network and the like.

The control unit 51 is CPU (Central Processing Unit) and the like that executes the program stored to the storage unit 52 and performs calculations and the like to execute a floorplan creation information generating method described later.

The input unit 53 is an input device such as a keyboard and a mouse. The input file group 11 and the like is input from the input unit 53 and stored to the storage unit 52. The output unit 54 is a display device such as a display that displays the generated floorplan creation information 14 and the group unplaceable information 17 and the like.

The storage unit 52 is a storage device such as a hard disk that stores a floorplan creation information generating program for executing the floorplan creation information generating method and information necessary for generating the input file group 11, the floorplan creation information 14, the group unplaceable information 17 and the like.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

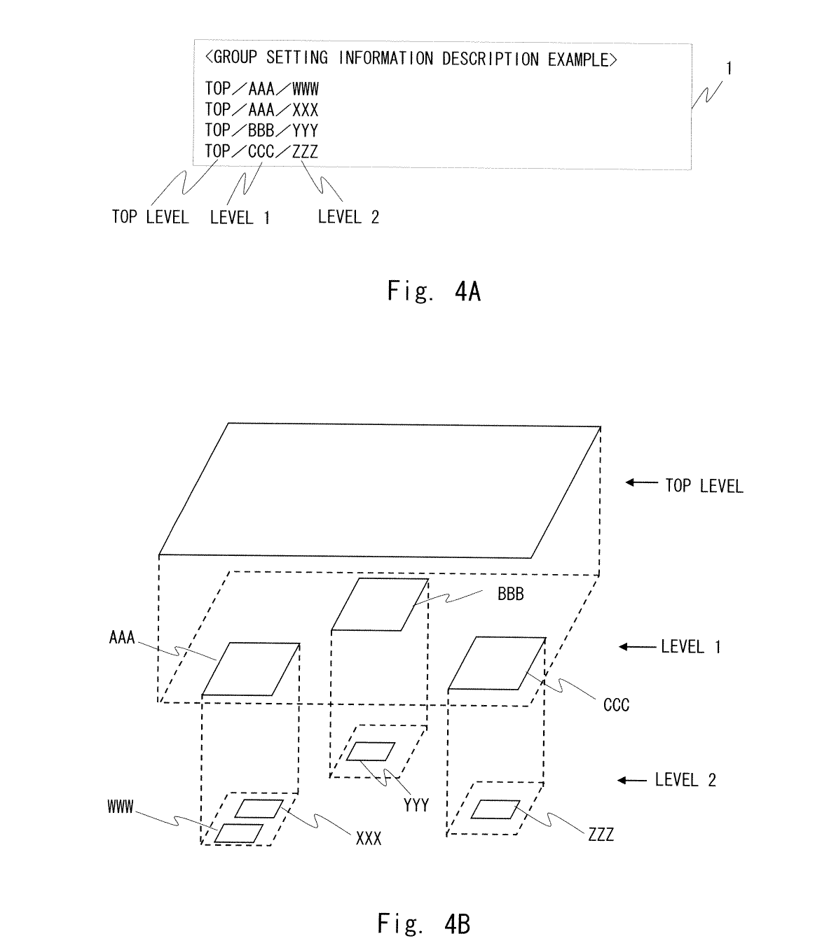

Next, the floorplan creation information generating method performed by the floorplan creation information generating device according to the first embodiment of the present invention is explained using FIGS. 3 to 7.

The flowchart of FIG. 3 shows a flow of the floorplan creation information generating method. As shown in the drawing, in the floorplan creation information generating method, firstly the group setting unit 4 sets the group (S21), and the circuit information extracting unit 12 calculates the number of circuit stages for the path regarding the set group (S22), the related hierarchical block evaluating unit 8 calculates delay in the path and the distance that satisfies the timing constraint in response to the stage number calculation result (S23), and the timing evaluation processing unit 9 confirms the timing for the distance calculated result (S24).

When the timing confirmation is OK (S24=YES), the floorplan creation information outputting unit 13 generates the floorplan creation information 14 (S25), and the process is completed. On the other hand, when the timing confirmation is not OK (S24=NO), the hierarchical evaluation processing unit 15 evaluates whether the hierarchy can be changed to the lower hierarchy (S30).

When the hierarchical evaluation is OK (S30=YES), the group correcting unit 10 corrects the group setting (S31) and sets the group again (S21). On the other hand, when the hierarchical evaluation is not OK (S30=NO), the unplaceable information creating unit 16 creates the unplaceable information (S32), and the process is completed.

Hereinafter, each step of FIG. 3 is explained in detail.

First, in S21 of FIG. 3, the group setting unit 4 sets the group to the functional block based on the netlist 2 and the group setting information 1. The group setting unit 4 reads hierarchical block specifying information provided from the group settfng information 1 and specifies a group name in which the functional module in the netlist 2 matches the group setting. Note that the group is a unit of circuit set according to the group setting information (the hierarchical block specifyfng information). As the group is set to each functional module and the hierarchical block is composed, the group, the hierarchical block, and the functional module respectively correspond one-to-one. For example, in the group with a certain specified function, the functional module including the function belongs to the group.

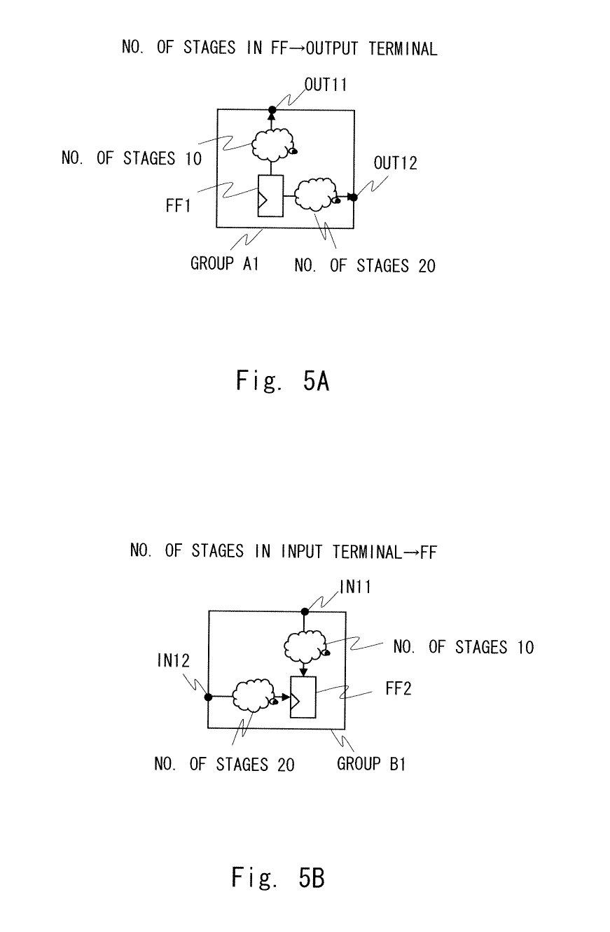

FIG. 4A is an example of the group setting information 1. For the group setting information 1, each line of FIG. 4A is the hierarchical block specifying information, and the hierarchical block (the functional module) is specified in the order of hierarchical level from the top level.

For example, the description “TOP/AAA/WWW” in the first line indicates that a group AAA belongs to level 1, which is a lower level of the top level, and a group WWW belongs to a level 2, which is a lower level of the group AAA.

FIG. 4B is an image diagram showing a hierarchical relationship when the group is set based on the group setting information 1 of FIG. 4A. A top level is a hierarchy in the top level. Only a top level group is set to the top level. All low-level functional modules, which are the group AAA, a group BBB, a group CCC, are included in the top level group.

The group AAA, the group BBB, and the group CCC are set to the level 1, which is a lower hierarchy of the top level. The low-level groups WWW and XXX are included in the group AAA, a low-level group YYY is included in the group BBB, and a low-level group ZZZ is included in the group CCC.

The level 2, which is a lower hierarchy of the level 1, is the bottom hierarchy, for example. The group WWW, the group XXX, the group YYY, and a group ZZZ are set to the level 2.

In S21, in the hierarchical structure as in FIG. 4B, the hierarchy is selected and the group is set to the functional module that belongs to the selected hierarchy. For example, the information including the hierarchical block belonging to the selected hierarchy is generated as the information indicating the set group, and the processes after S22 are performed based on this information. In the floorplan creation information generating method, firstly the hierarchy in the level 1 is selected, and when the timing violation, occurs, the lower level 2 is selected next.

Subsequently, in S22 of FIG. 3, the circuit information extracting unit 12 calculates the number of circuit stages for each group set by the group setting unit 4. For improvement in the calculation speed of timing delay, the timing delay is temporarily quantified using the number of circuit stages.

More specifically, the hierarchy block input and output stage number calculating unit 5 calculates the number of circuit stages between the sequential cell in the hierarchical block and the input or output terminal. The hierarchical block passing stage number calculating unit 6 calculates the number of circuit stages in the path that passes through the hierarchical block. The connection information between hierarchical blocks extracting unit 7 calculates the number of circuit stages between the hierarchical blocks. The sequential cell includes a plurality of flip-flops (FF) and calculates the number of circuit stages in the paths connected to the flip-flops on the basis of the flip-flops. Note that the number of circuit stages may be calculated by the unit of cell instead of the unit of flip-flop.

The hierarchical block input and output stage number calculating unit 5 refers to the netlist 2 and investigates the number of circuit stages from the flip-flops to all output terminals of the group to which the flip-flops belong for each group set by the group setting unit 4. Accordingly, for all the flip-flops in each group, the paths connecting between the flip-flops and all output terminals are obtained and the number of gate circuits placed on each path is counted.

Calculating the number of stages from the flip-flops to the output terminals generates stage number information (output stage number information) as in the following (formula 1).

Group[FF name] [group name/output terminal name]=number of stages (formula 1)

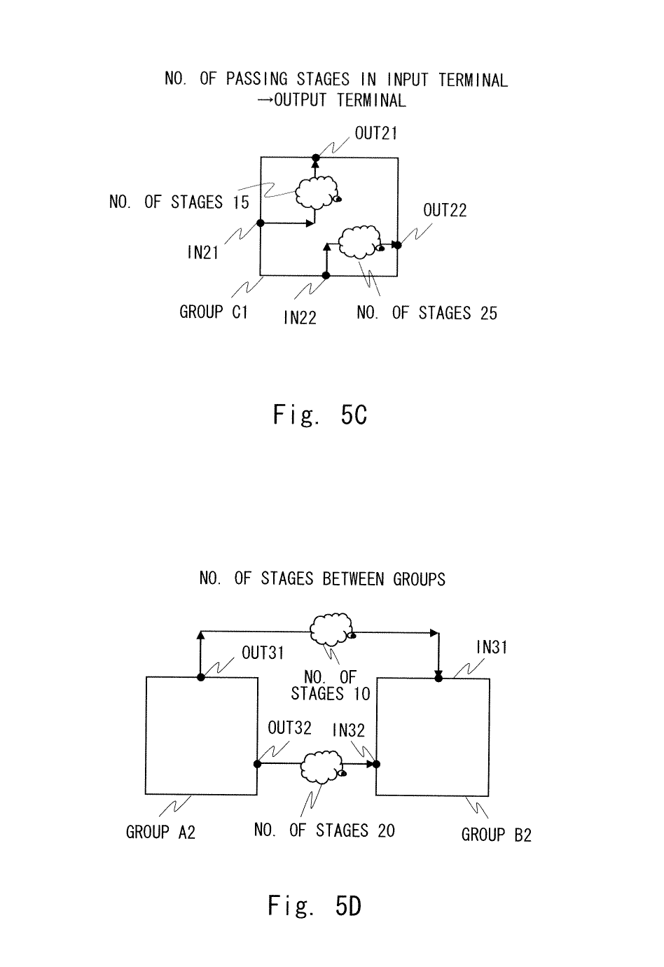

For example, in the case of a group A1 as shown in FIG. 5A, the number of circuit stages from FF1 to OUT11 is 10 and the number of circuit stages from FF1 to OUT12 is 20, thereby generating the stage number information as in the (formula 11) and (formula 12).

Group[FF1] [group A1/OUT11]=10 (formula 11)

Group[FF1] [group A1/OUT12]=20 (formula 12)

Moreover, the hierarchical block input and output stage number calculating unit 5 refers to the netlist 2 and investigates the number of circuit stages from all input terminals of the group to the flip-flips in the group for each group set by the group setting unit 4. That is, the hierarchical block input and output stage number calculating unit 5 obtains the paths connecting all input terminals and the flip-flops and counts the number of gate circuits placed on each path.

Calculating the number of stages from the input terminal to the flip-flops generates the stage number information (input stage number information) as in the following (formula 2) .

Group[Group name/input terminal name] [FF name]=number of stages (formula 2)

For example, in the case of a group B1 as shown in FIG. 5B, the number of cfrcuft stages from IN11 to FF2 is 10 and the number of circuit stages from IN12 to FF2 is 20, thereby generating the stage number information as in the following (formula 21) and (formula 22).

Group[group B1/IN11] [FF2]=10 (formula 21)

Group[group B1/IN12] [FF2]=20 (formula 22)

The hierarchical block passing stage number calculating unit 6 refers to the netlist 2 and investigates the number of circuit stages from the input terminal of the group to the output terminal of the group when there is no connection to the flip-flops in all input terminals and all output terminals of the group for each group set by the group setting unit 4. That is, the paths connecting all input terminals and all output terminals in the group are obtained for each group, the paths not passing through the flip-flops in the group are identified among all paths, and the number of gate circuits placed on this path is counted.

Calculating the number of passing stages from the input terminal to the output terminal generates the stage number information (passing stage number information) as in the (formula 3).

Group[group name/input terminal name] [group name/output terminal name]=number of stages (formula 3)

For example, in the case of a group C1 as shown in FIG. 5C, the number of cfrcuit stages from IN21 to 0UT21 is 15 and the number of circuit stages from IN22 to OUT22 is 25, thereby generating the stage number information as in the following (formula 31) and (formula 32).

Group[group C1/IN21] [group C1/OUT21]=15 (formula 31)

Group[group C1/IN22] [group C1/OUT22]=25 (formula 32)

For each group set by the group setting unit 4, the connection information between hierarchical blocks extracting unit 7 refers to the netlist 2 and investigates the number of circuit stages in all the input terminals and all the output terminals of the group for the part being connected via other than the respective group. That is, the paths connecting all the input terminals and all the output, terminals outside the group are obtained for each group, the paths not passing through the group are identified among all paths, and the number of gate circuits placed on this path is counted.

Calculating the number of stages between the groups generates the stage number information (stage number information between groups) as in the following (formula 4).

TOP[group name/output terminal name] [group name/input terminal name]=number of stages (formula 4)

For example, in the case of a group A2 and a group B2 as shown in FIG. 5D, the number of circuit stages from OUT31 to IN31 is 10 and the number of circuit stages from OUT32 to IN32 is 20, thereby generating the stage number information as in the following (formula 41) and (formula 42).

TOP[group A2/OUT31] [group B2/IN31]=10 (formula 41)

TOP[group A2/OUT32] [group B2/IN32]=20 (formula 42)

Next, in S23 of FIG. 3, the related hierarchical block evaluating unit 8 receives the evaluation function setting information 3 of the input file group 11 and calculates the timing delay and the distance satisfying the timing constraint based on the number of circuit stages calculated by the circuit information extracting unit 12.

The evaluation information setting information 3 includes a gate delay value, a distance delay value T, and cycle information F as shown below. The cycle information F is a cycle of a clock supplied to the flip-flops and is cycle time indicating one cycle time of a clock cycle. The cycle information F is time when data must be transmitted between the flip-flops and also the timing constraint.

G=Delay value per gate stage (gate delay value)
T=Delay value for unit wiring length (distance delay value)
F=Cycle information

The related hierarchical block evaluating unit 8 calculates the delay using the gate delay value G, the distance delay value T, the cycle information F, and the number of stages in the above (formula 1) to (formula 4). Therefore, as in the following (formula 5), a total number of stages D (total stage number information) is obtained from the number of stages extracted from the above (formula 1) to (formula 4).

The total number of stages D=(formula 1)+(formula 2)+(formula 3)+(formula 4) (formula 5)

Then, as in the following (formula 6), cell delay Tc (circuit delay information) is obtained by multiplying the above total number of stages D by the gate delay value G of the evaluation function setting information 3.

Cell delay Tc=D*G (formula 6)

Further, as in the following (formula 7), distance delay TX (distance delay infor mation) is obtained by subtracting the above cell delay Tc from the cycle information F of the evaluation function setting information 3.

Distance delay Tl=F−Tc (formula 7)

Furthermore, as in the following (formula 8), a distance L (distance information) necessary for satisfying the timing constraint between the groups is calculated by dividing the above distance information Tl by the distance delay value T of the evaluation function setting information 3.

Distance L=Tl/distance delay value T (formula 8)

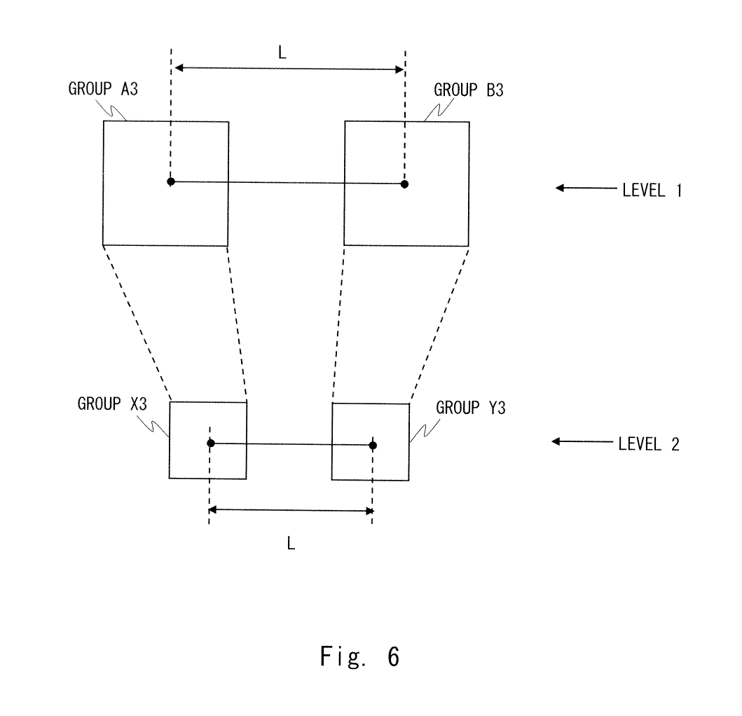

For example, in the example of the level 1 as in FIG. 6, the distance L between the group A3 and the group B3 can be calculated by substituting the number of stages from the flip-flops to the output terminals obtained by the above (formula 1) for the group A3, the number of stages from the input terminals to the flip-flops obtained by the above (formula 2) for the group B3, and the number of stages between the groups obtained by the above (formula 4) for the groups A3 and B3 into the above (formula 5) to (formula 8). This distance L is a parameter for creating the floorplan that satisfies the timing constraint. When the groups are placed at the distance below the distance L and the floorplan is created, it is guaranteed that the timing constraint is satisfied in the floorplan. Moreover, the distance L is a distance from a center of gravity (center) of the group to a center of gravity of another group.

Note that when the distance L is small, the timing is severe, and it is distant from the center of gravity to the output terminal or the input terminal, the position of the output terminal or the input terminal of the group may be adjusted to be close to the center of gravity to reduce the distance L.

Next, in S24 of FIG. 3, the timing evaluation processing unit 9 confirms the timing based on the distance L (the distance information) calculated by the related hierarchical block evaluating unit 8.

More specifically, for all the distances L between the groups calculated by the above (formula 8), the timing evaluation processing unit 9 evaluates whether the groups can be placed at the distance for the floorplan. When all the distances L are placeable, the timing constraint is satisfied, while when at least one distance L is unplaceable, the timing constraint is not satisfied. For example, the distance L is compared with a minimum distance necessary for the floorplan. When the distance L is smaller than the minimum distance, the distance L is placeable, while when the distance L is greater than the minimum distance, the distance L is unplaceable. An arbitrary value can be set to the minimum distance.

Next, when the timing confirmation is OK (S24=YES) in FIG. 3, that is, when the distance L is evaluated to be placeable for the groups, the floorplan creation information 14 outputting unit 13 generates and outputs the floorplan creation information in S25 of FIG. 3. The distance L (the distance information) between all the groups calculated by the above (formula 8) is generated as the floorplan creation information 14.

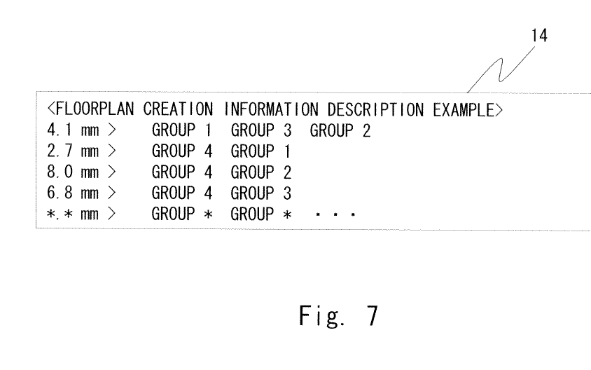

FIG. 7 is an example of the floorplan creation information 14. Each line of the floorplan creation information 14 describes a correspondence between the distance L between groups and connection information that is the paths between the groups. For example, in FIG. 7, the first line indicates that the distance from a group 1 to a group 2 via a group 3 is 4.1 mm or less, and the second line indicates that the distance from a group 4 to the group 1 is 2.7 mm or less.

When the timing confirmation is not OK (S24=NO) in FIG. 3, that is, when the distance L is evaluated to be the distance not possible to place the groups, in S30 of FIG. 3, the hierarchical evaluation processing unit 15 evaluates whether the hierarchy can be changed, in other words, the hierarchy of the group setting is the bottom hierarchy of the group setting. As the timing constraint is not satisfied by the currently selected hierarchal group, the group must be changed to satisfy the timing constraint. When the current hierarchy is not the bottom hierarchy, the hierarchy can be changed to the lower hierarchy, while when the current hierarchy is the bottom hierarchy, the hierarchy cannot be changed.

When the hierarchy can be changed in S30 of FIG. 3, that is, when the hierarchy is evaluated not to be the bottom hierarchy, in S31 of FIG. 3, the group correcting unit 10 changes the current hierarchy to the lower hierarchy and corrects the group setting.

For example, as shown in FIG. 6, the distance L between the groups is calculated in the hierarchy of the level 1, and when the timing confirmation is not OK, the hierarchy is changed to the hierarchy of the lower level 2 as in FIG. 6, and the distance L between the groups is calculated. Changing the hierarchy of the group setting to the lower hierarchy reduces the size of the target group, and thus the distance L can be reduced and the timing can be satisfied.

When the hierarchy cannot be changed in S30 of FIG. 3, that is, when the hierarchy is evaluated to be the bottom hierarchy, the unplaceable information creating unit 16 creates and outputs the group unplaceable information 17 in S32 of FIG. 3. For example, the group unplaceable information 17 includes the distance L between the groups calculated for each hierarchy and also the distance L between the groups that causes a timing violation.

Moreover, when the group unplaceable information 17 is output, the floorplan that satisfies the timing constraint cannot be created under the current condition. Therefore, the input file group 11 may be corrected based on the group unplaceable information 17. For example, the cycle information F may be increased, the timing constraint may be relaxed, or the netlist 2 may be corrected for the path that causes the timing violation.

As described above, in this embodiment, the group is set to the netlist having the hierarchical structure, and the floorplan creation information indicating the distance necessary for satisfying the timing constraint between groups is created. When the floorplan is created using the floorplan creation information, the timing constraint between the groups for the floorplan can be satisfied in advance, thus the floorplan does not need to be corrected. This prevents an iteration in the floorplan design and reduces the design period.

### Second Embodiment

Hereinafter, a second embodiment of the present invention is explained with reference to the drawings. In this embodiment, in a similar manner as the first embodiment, floorplan creation information is generated and a floorplan is created based on the floorplan creation information.

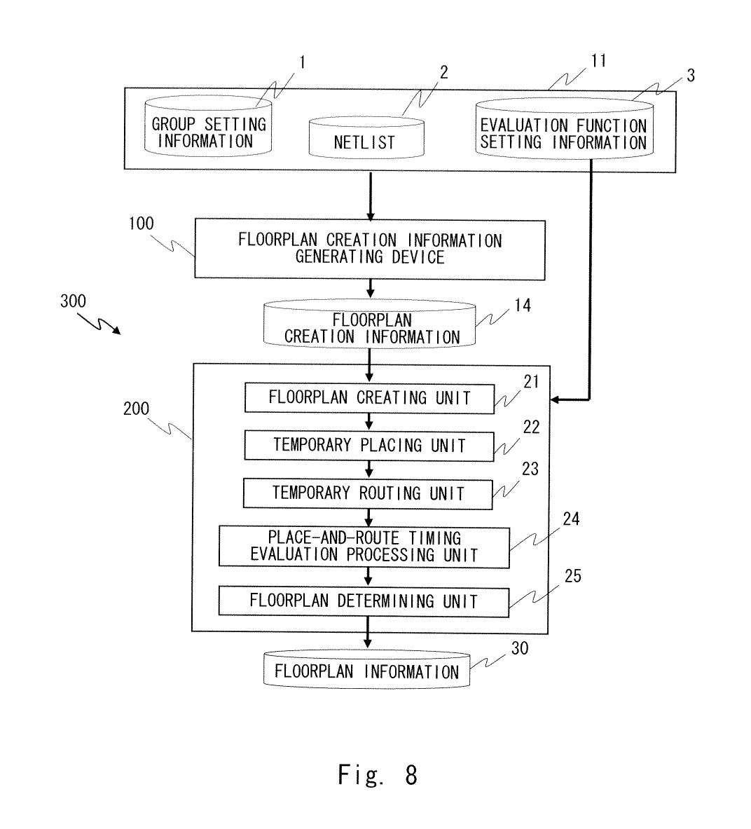

FIG. 8 shows a functional configuration of the floorplan optimizing device according to the second embodiment of the present invention. A floorplan optimizing device 300 includes a floorplan creation information generating device 100 and a floorplan creating device 200. The input file group 11, the floorplan creation information generating device 100, and the floorplan creation information 14 in FIG. 7 have the similar configuration as FIG. 1. Note that a hardware configuration of the floorplan optimizing device 300 is similar to FIG. 2. Executing a floorplan optimizing program on the hardware of FIG. 2 realizes each function of the floorplan optimizing device and each process of the floorplan optimizing method.

The floorplan creating device 200 creates the floorplan based on the floorplan creation information 14. The floorplan creating device 200 includes a floorplan creating unit 21, a temporary placing unit 22, a temporary routing unit 23, a place-and-route timing evaluation processing unit 24, and a floorplan determining unit 25.

The floorplan creating unit 21 receives the floorplan creation information 14 and creates a floorplan (floorplan information) of an entire semiconductor chip. The temporary placing unit 22 temporarily places each circuit on a layout surface of the semiconductor chip based on the created floorplan. The temporary routing unit 23 performs temporary routing between each circuit, which is temporarily placed. For example, the temporary placing unit 22 and the temporary routing unit 23 can be realized by an automatic place-and-route tool and the like.

The place-and-route timing evaluation processing unit 24 verifies timing delay and confirms whether there is the timing violation in place-and-route information for the temporarily placed and routed circuits. For example, the place-and-route timing evaluation processing unit 24 can be realized by a timing analysis tool and the like.

When the timing constraint is satisfied as a result of the timing confirmation, the floorplan determining unit 25 outputs the temporarily placed and routed floorplan as floorplan information 30.

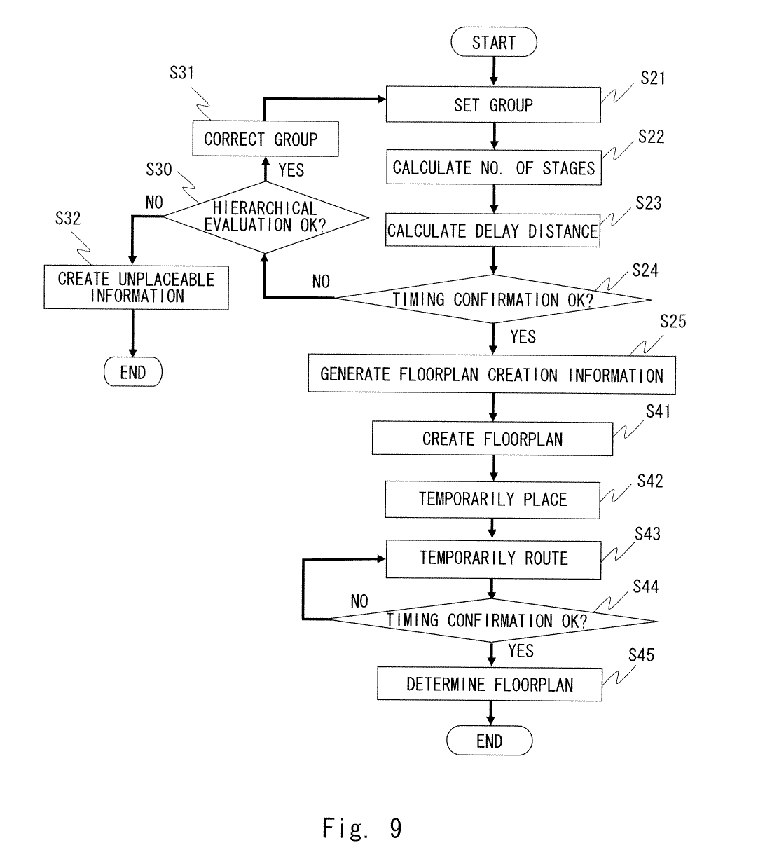

Next, the floorplan optimizing method performed by the floorplan optimizing device according to the second embodiment of the present invention is explained using the flowchart of FIG. 9. In FIG. 9, S21 to S25 and S30 to S32 is a floorplan creation information generating process executed by the floorplan creation information generating device 100 and is similar to FIG. 2. Accordingly, the floorplan creation information generating device 100 generates the floorplan creation information 14 in S21 to S25 and S30 to S32. After that, the floorplan creating device 200 creates the floorplan information 30 in S41 to S45.

In the floorplan creating device 200, firstly the floorplan creating unit 21 receives the floorplan creation information 14 generated in S25 and creates the floorplan (the floorplan information) (S41). That is, a position of each group is determined and the floorplan is created so that the distance for placing each group will be smarler than the distance L included in the floorplan creation information 14. At this time, the group may be placed at least closer than the distance L.

It is common that there are a plurality of paths between the groups and a plurality of groups, and thus there are a plurality of distances L of the floorplan creation information 14. Therefore, it is preferable to create the floorplan using necessary distance L.

For example, the paths in the group are ignored and the paths between the groups are focused to use the distance L. More specifically, when there are a plurality of paths from the group 1 to the group 4, the smallest distance L necessary in the unit of groups is used. Moreover, when there is a connection from the group to the plurality of groups, floorplanning from the group with the smallest value of the necessary distance L enables floorplanning with first priority to the groups with the severest timing.

Further, although the present invention creates the floorplan with a timing element as the most important item, other parameters such as a length of temporary routing and an intersection of the temporary routing may be considered to create the floorplan. Furthermore, when the value of the necessary distance L is large, as it is possible to evaluate that the timing between the groups is not severe, even in the case in which the groups are placed far and bypass wiring is created, there is no problem in the timing.

Next, the temporary placing unit 22 temporarily places the functional modules and circuits included in the functional modules to the determined positions of the groups on the layout surface of the semiconductor chip based on the created floorplan information (S42). Next, the temporary routing unit 23 performs the temporary routing to connect between the functional modules and circuits, which are temporarily placed, based on the floorplan information (S43).

Subsequently, the place-and-route timing evaluation processing unit 24 performs the timing confirmation based on the place-and-route information for the temporarily placed and routed circuits (S44). Therefore, the place-and-route evaluation processing unit 24 evaluates whether the timing constraint is satisfied for the paths between all the placed and routed circuits. In S44, when the timing constraint is not satisfied (S44=NO), the temporary routing unit 23 performs the temporary routing again so as to satisfy the timing constraint (S43). In S44, when the timing constraint is satisfied (S44=YES), the floorplan determining unit 25 determines the floorplan with the place-and-route information and outputs the current floorplan information 30 (S45).

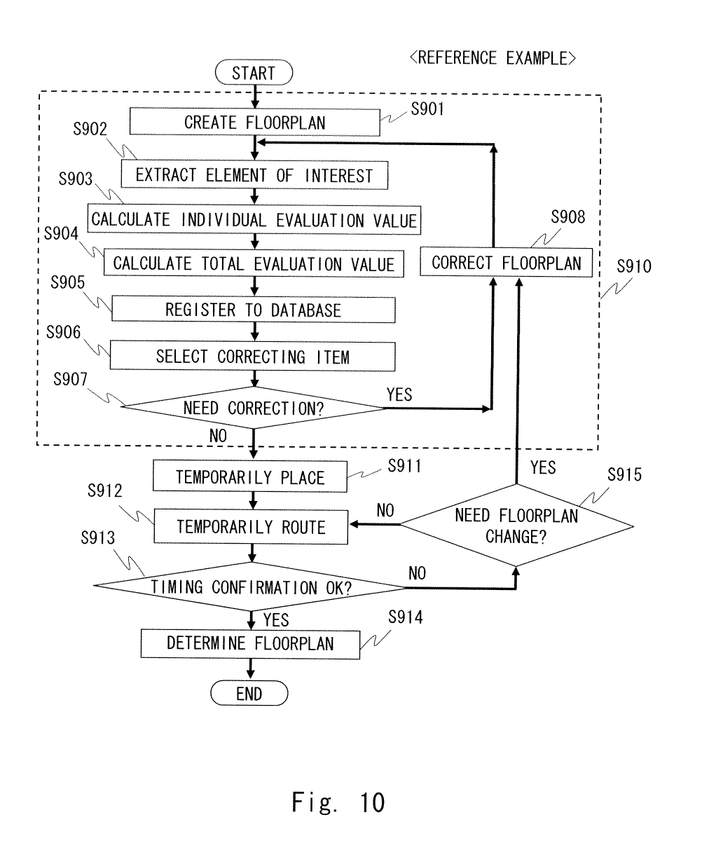

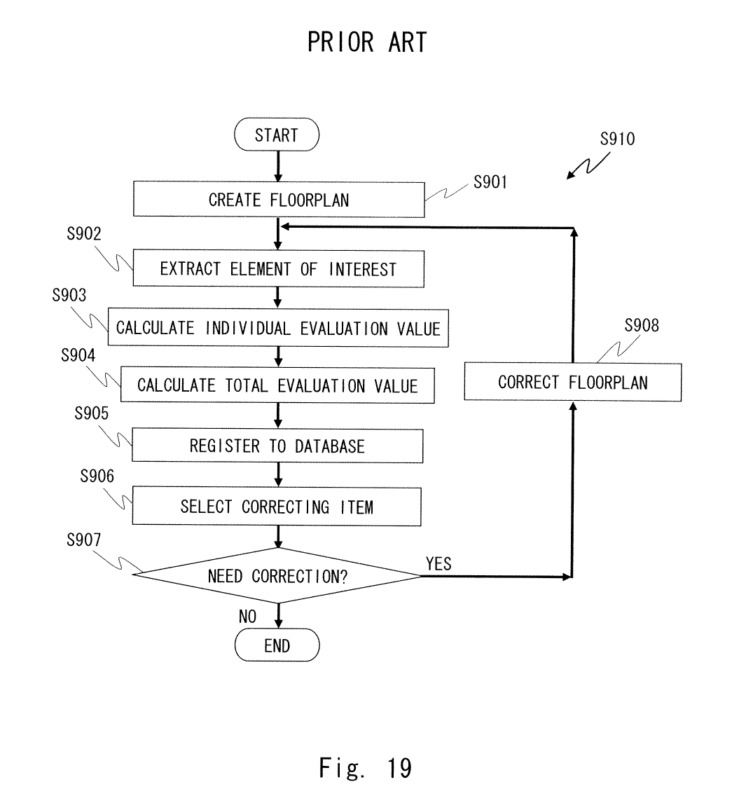

A reference example of the floorplan optimizing method before applying the present invention is shown in FIG. 10 in order to compare and explain the floorplans before and after applying the present invention. In FIG. 10, S910 is similar to the floorplan creating method in FIG. 19 according to the related art.

That is, in the reference example, in a similar manner as FIG. 19, the floorplan is created (S901), elements of interest are extracted from the floorplan (S902), individual evaluation values is calculated from the floorplan (S903), the total evaluation value is calculated from the individual evaluation value (S904), the individual evaluation value and the total evaluation value are registered to a database (S905), the correcting item is selected from the individual evaluation value and the total evaluation value (S906), and the floorplan is evaluated whether the correction is needed for the selected correcting item (S907). When the floorplan needs the correction in S907, the floorplan is corrected (S908).

When the floorplan needs no correction in S907, the temporary placement is performed based on the generated floorplan (S911), the temporary routing is performed between the temporarily placed circuits (S912), and the timing confirmation is performed for the temporarily placed and routed circuits (S913).

In S913, when the timing constraint is satisfied by the timing confirmation, the floorplan is determined by the placed-and-routed information, and floorplan information is output (S914).

In S913, when the timing constraint is not satisfied by the timing confirmation, it is evaluated whether the floorplan needs a change, that is, whether the cause of the timing violation is in the floorplan (S915).

In S915, when the floorplan needs no change, the temporary routing is performed again (S912) and the timing is confirmed (S913).

In S915, when the floorplan needs a change, the process returns to the floorplan creating process and the floorplan is corrected (S908). After the floorplan is corrected, the correction of the floorplan is repeated until the timing violation is solved by the timing confirmation, thereby generating the iteration.

In the reference example, in a similar manner as the related art of FIG. 19, a line length of the temporary routing, the intersection of the virtual routing, the logic module relationship, the hard macrocell relationship, and the area of the group region are extracted as the individual evaluation items and the floorplan is evaluated as an entire score based on the placement information, the connection information, and the group information. However, the timing between the logic modules is not considered. Therefore, in FIG. 10, when the floorplan is created (S910), the temporary placement (S911) and the temporary routing (S912) is performed, the timing constraint between the logic modules cannot be satisfied in the timing confirmation (S913), and the cause thereof is evaluated to be in the floorplan (S915), the floorplan needs the correction (S910), thereby generating the iteration and increasing the design period.

Especially, when the floorplan is created based on the connection information and the line length of the temporary routing without taking account of the timing and the floorplan needs correction as a result of the timing analysis after the temporary placement and routing, it takes time to evaluate whether the cause of the timing violation is in the placement and an improvement of the timing violation cannot be confirmed without correcting the floorplan and performing the timing verification. Thus several iterations occur and the design period is increased.

On the other hand, in the present invention, as shown in FIG. 9, the floorplan creation information 14, which is the distance that satisfies the timing constraint between the groups, is generated and the floorplan is created based on the floorplan creation information 14. This suppresses generation of the timing violation in the floorplan in advance. Accordingly, as the timing violation caused by the floorplan does not occur, the iteration of the floorplan creation can be prevented. In the present invention, as shown in FIG. 9, after performing the temporary placement (S42) and the temporary routing (S43), the second timing confirmation (S45) is performed and when the timing constraint is satisfied, the floorplan is determined (S45), and the process is completed. Even when the timing constraint is not satisfied by the second timing confirmation (S44), the floorplan needs no correction, the process returns to the temporary routing (S43), and rerouting is performed so as to solve the timing violation. Thus the design period can be reduced.

A specific floorplan example is explained with the case of creating the floorplan by the reference example of FIG. 10 and the case of creating the floorplan by the present invention of FIG. 9.

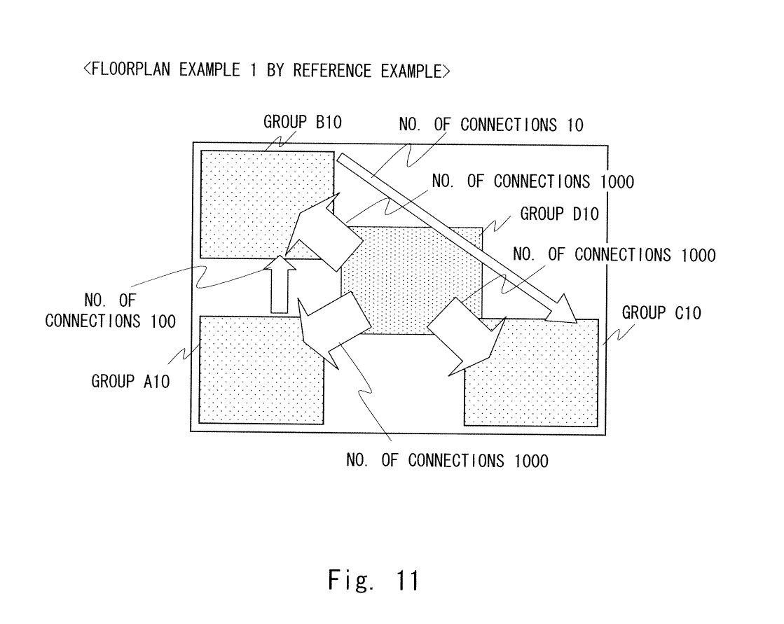

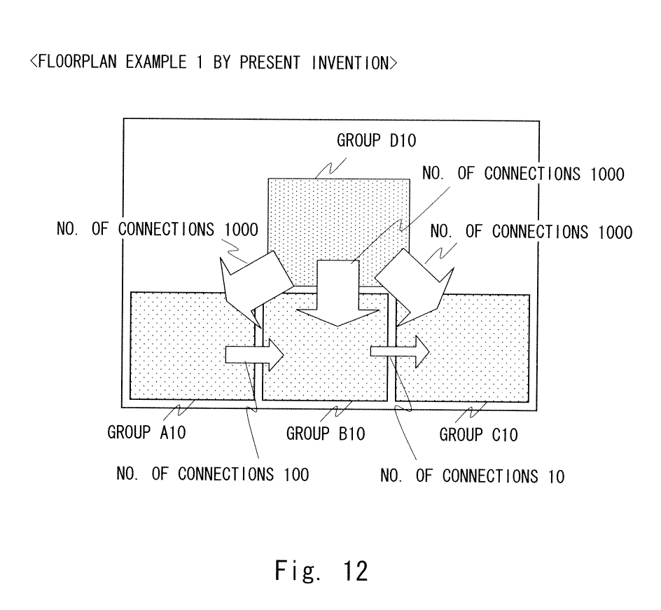

Firstly, as an example 1 of the floorplan, a floorplan by the reference example is shown in FIG. 11 and a floorplan by the present invention is shown in FIG. 12.

In this example, the number of connections between a group A10 and a group B10 is 100 and the number of connections between the group B10 and a group C10 is 10, which are small numbers, while the number of connections from a group D10 to the group A10, the group B10 and the group C10 is 1000, which is a large number.

The floorplan by the reference example takes account of the number of connections but not the timing between the groups. Therefore, in the reference example, the floorplan is created as shown in FIG. 11, in which the group D10 is placed on the central part of the layout surface, and the group A10, the group B10, and the group C10 are placed on corner parts around the layout surface to surround the circumference of the group D10.

However, as for the path from the group A10 to be connected to the group C10 via the group B10, when the number of connections is small and the timing is severe, the placement taking account only of the connection relationship as in FIG. 11 cannot satisfy the timing constraint and requires the correction of the floorplan. Accordingly, as in the reference example of FIG. 10, an error occurs at the timing confirmation after the floorplan is created, thereby generating a need to correct the floorplan and the iteration.

On the other hand, in the present invention, the floorplan is created based on the floorplan creation information 14 indicating the distance L that satisfies the timing constraint as above. Thus, the floorplan creation information includes the distance among the group A10, the group B10, and the group C10 to satisfy the timing constraint for the path that is connected from the group A10 to the group C10 via the group B10.

Therefore, in the present invention, as shown in FIG. 12, the group A10, the group B10, and the group C10 are placed within the range of the distance described in the floorplan creation information 14. Then, the group D10 is placed to be connected to the group A10, the group C10, and the group C10. Thus, the timing constraint of the group A10, the group B10, and the group C10 is always satisfied.

That is, in the present invention of FIG. 9, as in the reference example of FIG. 10, there is no iteration such that the process returns to correct the floorplan from the timing confirmation after the temporary placing and routing, and thus preventing the increase in the design period.

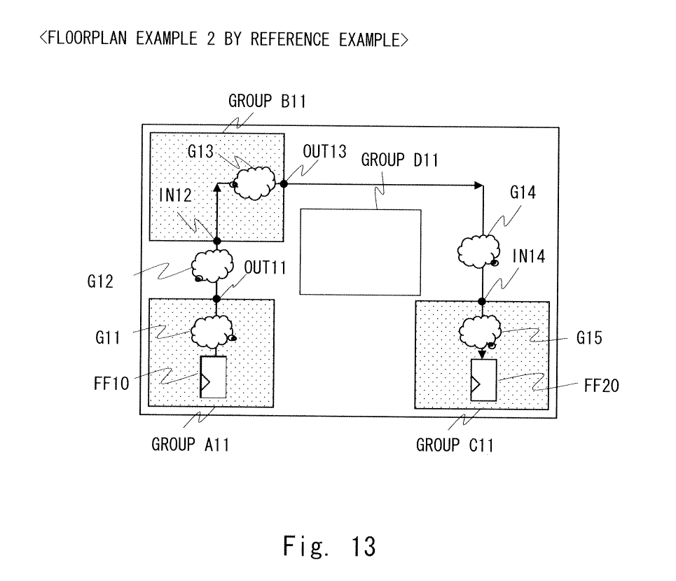

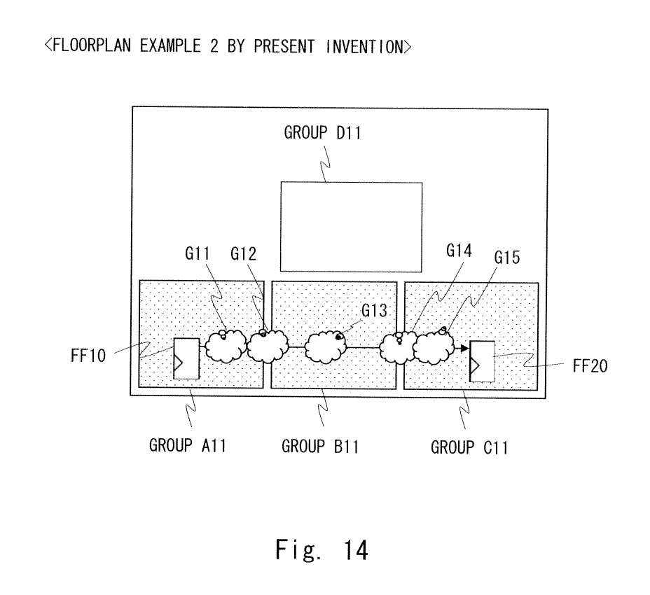

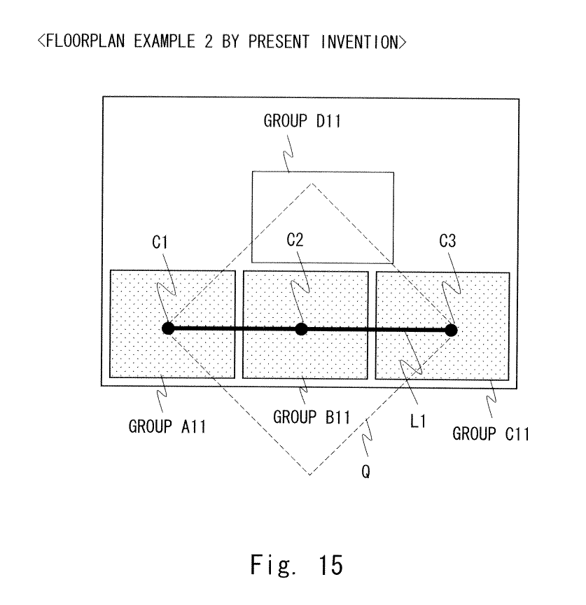

Next, as an example 2 of the floorplan, the floorplan by the reference example is shown in FIG. 13 and the floorplan by the present invention is shown in FIGS. 14 and 15.

This example focuses on the placement of a group A11, a group B11, and a group C11 and is explained with the case of calculating the distance L of the floorplan creation information 14 for the path of the group A11, the group B11, and the group C11.

In the reference example, the floorplan is created as shown in FIG. 13 in a similar manner as FIG. 11, in which a group D11 is placed on the central part of the layout surface, and the group A11, the group B11, and the group C11 are placed on the corner parts of the layout surface circumference.

However, as mentioned above, as the timing violation could occur in this floorplan, the distance L for satisfying the timing constraint is calculated in the present invention. A calculation example for the path from the group A11 to the group C11 via the group B11 is explained here.

In this example, the gate delay value G, the distance delay value T, and the cycle information F of the evaluation function setting information 3 shall be the following (formula 101).

G=0.1 ns, T=1.1 ns/mm, and F=1.0 ns (formula 101)

The number of stages G11 from FF10 of the group A11 to an output terminal OUT11 of the group A11 is obtained by the following (formula 102), the number of stages G12 from the output terminal OUT11 of the group A11 to an input terminal IN12 of the group B11 is obtained by the following (formula 103), the number of stages G13 from the input terminal IN12 of the group B11 to an output terminal OUT12 of the group B is obtained by the following (formula 103), the number of stages G14 from an output terminal OUT13 of the group B11 to an input terminal IN14 of the group C11 is obtained by the following (formula 104), and the number of stages G15 from the input terminal IN14 of the group C11 to FF20 of the group C11 is obtained by the following (formula 105).

G11=group[FF10] [group A11/OUT11]=20 stages (formula 102)

G12=TOP[group A11/OUT11] [group B11/IN12]=3 stages (formula 103)

G13=group[group B11/IN12] [group B11/OUT13]=10 stages (formula 104)

G14=T0P[group B11/0UT13] [group C11/IN14]=5 stages (formula 105)

G15=group[group C11/IN14] [FF20]=17 stages (formula 106)

From these (formula 102) to (formula 106), the total number of stages D is obtained by the following (formula 107).

D=group[FF10] [group A11/OUT11]+TOP[group A1/OUT11] [group B11/IN12]+group[group B11/IN12] [group B11/OUT13]+TOP[group B11/OUT13] [group C11/IN14]+group[group C11/IN14] [FF20]=20+3+10+5+17=55 stages (formula 107)

From this (formula 107) and the above (formula 101), the cell delay Tc is obtained by the following (formula 108).

Tc=D*G=55*0.1=5.5 ns (formula 108)

From this (formula 108) and the above (formula 101), the distance delay Tl is obtained by the following (formula 109).

Tl=F−Tc=1.0−5.5=4.5 ns (formula 109)

Accordingly, from this (formula 109) and the above (formula 101), the distance L necessary for satisfying the cycle informatfon F is obtained by the following (formula 110).

L=Tl/T=4.5 ns/1.1≈4.1 mm

As described above, by placing the group A11 to the group C11 via the group B11 at 4.1 mm or less, the timing constraint can be satisfied.

When the number of lines from the group D11 to the group A11, the group B11, and the group C1 is large, a floorplan as in FIG. 13 is generally created in the reference example. However, in the present invention, the group A11, the group B11, and the group C11 are placed at the distance of 4.1 mm or less as shown in FIG. 14 taking account of the timing constraint between the groups. When the timing of the path for the group A11, the group B11, and the group C11 is severe, the floorplan is created so that the path of the group A11, the group B11, and the group C11 will be a minimum path.

In order to place the group A11, the group B11, and the group C11 at the distance of 4.1 mm or less, the floorplan is created based on a center of gravity of each group as shown in FIG. 15. The distance of a straight line L1 for connecting a center of gravity C1 of the group A11 to a center of gravity C3 of the group C11 via a center of gravity C2 of the group B11 should be 4.1 mm or less.

The center of gravity C2 of the group B11 shall be a halfway point of the straight line L1 here. That is, the center of gravity of the group through which the path passes, that is, the group positioned halfway along the path, shall be the middle of the straight line L1. Then, suppose a square Q with this straight line L1 as a diagonal line. The center of gravity C1 of the group A11 and the center of gravity C2 of the group C11 are placed within a range in which the entire length of the diagonal line L1 is 4.1 mm or less with the center of gravity C2 at the center.

Then, the floorplan that does not cause the timing violation in the path of the group A11, the group B11, and the group C11 can be created without generating the iteration.

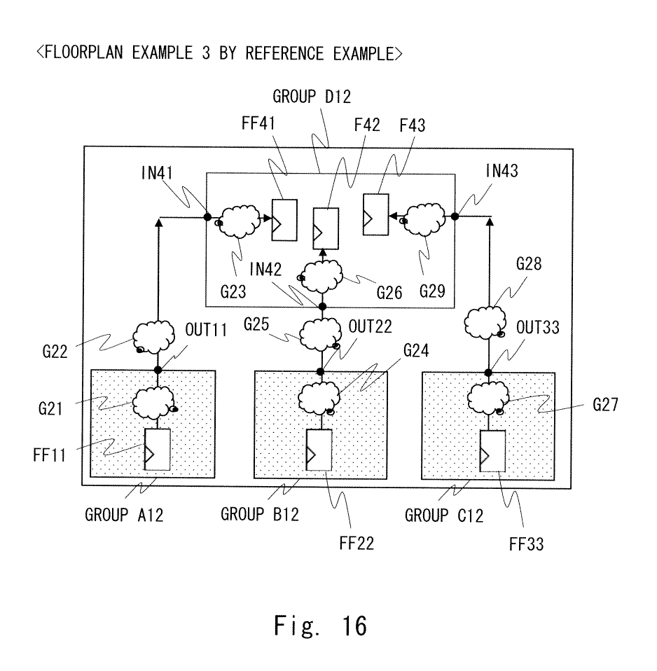

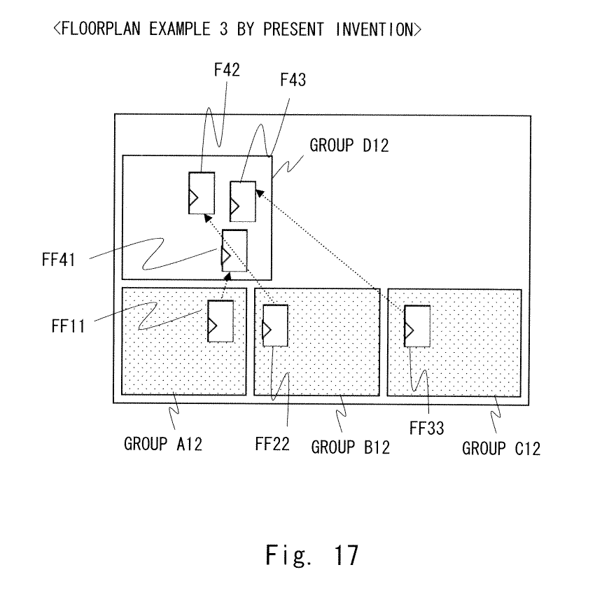

Next, as an example 3 of the floorplan, a floorplan by the reference example is shown in FIG. 16 and a floorplan by the present invention is shown in FIG. 17.

This example focuses on the placement of a group D12 respectively connected to a group A12, a group B12, and a group C12 and is explained with the case of calculating the distance L of the floorplan creation information 14 for the path of the group D12 to the group A12, the group B12, and the group C12.

In the reference example, as shown in FIG. 16, since the group D12 has connections to the group A12, the group B12, and the group C12, the group D12 is usually placed on the central part of the layout surface.

However, since the timing violation may occur between the group D12 and each group, the present invention calculates the distance L that satisfies the timing constraint. The timing is severe only from the group D12 to the group A12. A calculation example of non-severe timings from the group D12 to the group B12 and from the group D12 to the group C12 is explained.

The gate delay value G, the distance delay value T, and the cycle information F of the evaluation function setting information 3 shall be the following (formula 201).

G=0.1 ns, T=1.1 ns/mm, and F=10 ns (formula 201)

The number of stages G21 from FF11 of the group A12 to the output terminal OUT11 of the group A12 is obtained by the following (formula 202), the number of stages G22 from the output terminal 0UT11 of the group A12 to an input terminal IN41 of the group D12 is obtained by the following (formula 203), and the number of stages G23 from the input terminal IN41 of the group D12 to FF41 of the group D12 is obtained by the following (formula 204).

G21=group[FF11] [group A12/OUT11]=45 stages (formula 202)

G22=TOP[group A12/OUT11] [group D12/IN41]=3 stages (formula 203)

G23=group[group D12/IN41] [FF41]=22 stages (formufa 204)

Moreover, the number of stages G24 from FF22 of the group B12 to an output terminal OUT22 of the group B12 is obtained by the following (formula 205), the number of stages G25 from the output terminal OUT22 of the group B12 to an input terminal IN42 of the group D12 is obtained by the following (formula 206), and the number of stages G26 from the input terminal IN42 of the group D12 to FF42 of the group D12 is obtained by the following (formula 207).

G24=group[FF22] [group B12/OUT22]=20 stages (formula 205)

G25=TOP[group B12/OUT22] [group D12/IN42]=3 stages (formula 206)

G26=group[group D12/IN42] [FF42]=2 stages (formula 207)

Further, the number of stages G27 from FF33 of the group C12 to an output terminal OUT33 of the group C12 is obtained by the following (formula 208), the number of stages G28 from the output terminal OUT33 of the group C12 to an input terminal IN43 of the group D12 is obtained by the following (formula 209), and the number of stages G29 from the input terminal IN43 of the group D12 to FF43 of the group D12 is obtained by the following (formula 210).

G27=group[FF33] [group C12/OUT33]=4 stages (formula 208)

G28=TOP[group C12/OUT33] [group D12/IN43]=3 stages (formula 209)

G29=group[group D12/IN43] [FF43]=5 stages (formula 210)

As for the path from the group A12 to the group D12, from the above (formula 202) to (formula 204) and the above (formula 201), the total number of stages D is obtained by the following (formula 211), the cell delay Tc is obtained by the following (formula 212), the distance delay Tl is obtained by the following (formula 213), and the distance L necessary for satisfying the cycle information F is obtained by the following (formula 214).

D=group[FF11] [group A12/OUT11]+TOP[group A12/OUT11] [group D12/IN41]+group[group D12/IN41] [FF41]=45+3+22=70 stages (formula 211)

Tc=D*G=58*0.1=7.0 ns (formula 212)

Tl=F−Tc=10−7.0=3.0 ns (formula 213)

L=Tl/T=3.0 ns/1.1≈12.7 mm (formula 214)

As for the path from the group B12 to the group D12, from the above (formula 205) to (formula 207) and the above (formula 201), the total number of stages D is obtained by the following (formula 215), the cell delay Tc is obtained by the following (formula 216), the distance delay Tl is obtained by the following (formula 217), and the distance L necessary for satisfying the cycle Information F is obtained by the following (formula 218).

D=group[FF22] [group B12/OUT22]+TOP[group B12/OUT22] [group D12/IN42]+group[group D12/IN42] [FF42]=20+3+2=25 stages (formula 215)

Tc=D*G=25*0.1=2.5 ns (formula 216)

Tl=F−Tc=10−2.5=7.5 ns (formula 217)

L=Tl/T=7.5 ns/1.1≈6.8 mm (formula 218)

As for the path from the group C12 to the group D12, from the above (formula 208) to (formula 210) and the above (formula 201), the total number of stages D is obtained by the following (formula 219), the cell delay Tc is obtained by the following (formula 220), the distance delay Tl is obtained by the following (formula 221), and the distance L necessary for satisfying the cycle information F is obtained by the following (formula 222).

D=group[FF33] [group C12/OUT33]+TOP[group C12/OUT33] [group D12/IN43]+group[group D12/IN42] [FF43]=4+3+5=12 stages (formula 219)

Tc=D*G=12*0.1=1.2 ns (formula 220)

Tl=F−Tc=10−1.2=8.8 ns (formula 221)

L=Tl/T=8.8 ns/1.1≈8.0 mm (formula 222)

From the above result, the groups are placed to the position at the distance of the above (formula 214), (formula 218), and (formula 222) or less. Then the floorplan that does not cause the timing violation in the paths between the group D and each group can be created without generating the iteration.

Since the distance from the group A12 to the group D12 is 2.7 mm or less, the distance from the group B12 to the group D12 is 6.8 mm or less, and the distance from the group C12 to the group D12 is 8.0 mm or less, the distance from the group A12 to the group D12 is short and the distance from the group C12 to the group D12 is long. In this case, it is not necessary to place the group D12 on the center and the group D12 may be placed close to the group A12. That is, as shown in FIG. 17, the floorplan is created in which the group D12 is placed to the position close to the group A12 and also away from the group C12.

As described above, in this embodiment, in a similar manner as the first embodiment, the floorplan creation information indicating the distance necessary for satisfying the timing constraint between the groups is created and the floorplan is created based on the floorplan creation information. Then, the timing constraint between the groups is always satisfied, thereby eliminating the need to correct the floorplan. This prevents the iteration of the floorplan design and reduces the design period.

Note that the present invention is not limited to the above embodiments and can be changed as appropriate within the range not departing from the scope. For example, although the distance is explained as the floorplan creation information, margin information may be included in the floorplan creation information and the floorplan may be created in the range of the margin. Further, although the floorplan creation information and the floorplan is created based on the center of the gravity (center) of the group, the position of the center of gravity may be changed to satisfy the timing constraint. Although the shape of the group (functional module) is generally square here, it may be other shapes such as rectangular in order to satisfy the timing constraint.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A floorplan creation information generating method comprising:
storing a netlist including connection information of a plurality of circuit modules and group setting information for setting a group to the plurality of circuit modules to a storage unit;
setting the group to the plurality of circuit modules based on the netlist and the group setting information;
calculating a distance that satisfies a timing constraint between the set groups; and
generating floorplan creation information for creating a floorplan including the calculated distance between the groups.

2. The floorplan creation information generating method according to claim 1, wherein the netlist includes a hierarchical structure in which the plurality of circuit modules are sectionalized into a plurality of hierarchical levels.

3. The floorplan creation information generating method according to the claim 2, wherein
the group setting information specifies the circuit module to which the group is set by each of the hierarchical level, and
in the setting of the group, the hierarchical level is selected based on the group setting information, and the group is set to the plurality of circuit modules at the selected hierarchical level.

4. The floorplan creation information generating method according to claim 3, wherein in the calculation of the distance, when the distance satisfying the timing constraint between the set groups cannot be calculated, the hierarchical level lower than the hierarchical level of the selected group is selected, and the group is set to the plurality of circuit modules again at the selected hierarchical level.

5. The floorplan creation information generating method according to claim 1, wherein the distance is calculated based on circuit delay of a connection path that connects a first flip-flop in a first group to a second flip-flop in a second group.

6. The floorplan creation information generating method according to claim 5, wherein the circuit delay includes circuit delay from the first flip-flop to an output terminal of the first group, circuit delay from the output terminal of the first group to an input terminal of the second group, and circuit delay from the input terminal of the second group to the second flip-flop.

7. The floorplan creation information generating method according to claim 6, wherein the circuit delay includes circuit delay from an input terminal to an output terminal in a third group that is connected between the first group and the second group.

8. The floorplan creation information generating method, according to claim 5, wherein the circuit delay is calculated based on the number of stages in a delay circuit placed on the connection path.

9. The floorplan creation information generating method according to claim 8, further comprising storing a delay value by the delay circuit to the storage unit, wherein the circuit delay is calculated based on the number of stages fn the delay circuit and the delay value by the delay circuit.

10. The floorplan creation information generating method according to claim 9, wherein the circuit delay is calculated by multiplying the number of stages in the delay circuit by the delay value by the delay circuit.

11. The floorplan creation information generating method according to claim 5, further comprising storing constraint time to the storage unit, the constraint time being the timing constraint between the first flip-flop and the second flip-flop, wherein the distance is calculated based on the circuit delay and the constraint time.

12. The floorplan creation Information generating method according to claim 11, wherein the distance is calculated by subtracting the circuit delay from the constraint time.

13. The floorplan creation information generating method according to claim 11, wherein the constraint time is cycle information of a clock supplied to the first flip-flop and the second flip-flop.

14. The floorplan creation information generating method according to claim 5, further comprising storing a delay value per unit length of a line that composes the connection path to the storage unit, wherein the distance is calculated based on the circuit delay and the delay value of the line.

15. The floorplan creation information generating method according to claim 14, wherein the distance is calculated by dividing the circuit delay by the delay value of the line.

16. The floorplan creation information generating method according to claim 11, further comprising storing a delay value per unit length of a line that composes the connection path to the storage unit, wherein the distance is calculated based on the circuit delay, the constraint time, and the delay value of the line.

17. The floorplan creation information generating method according to claim 16, wherein the distance is calculated by dividing a value obtained by subtracting the circuit delay from the constraint time by the delay value of the line.

18. A non-transitory computer readable medium storing a floorplan creation information generating program that causes a computer to execute a floorplan creation information generating method, the floorplan creation information generating method comprising:
storing a netlist including connection information of a plurality of circuit modules and group setting information for setting a group to the plurality of circuit modules to a storage unit;
setting the group to the plurality of circuit modules based on the netlist and the group setting information;
calculating a distance that satisfies a timing constraint between the set groups; and
generating floorplan creation information for creating a floorplan including the calculated distance between the groups.

19. A floorplan creation information generating device comprising:
a storage unit that stores a netlist including connection information of a plurality of circuit modules and group setting information for setting a group to the plurality of circuit modules:
a group setting unit that sets the group to the plurality of circuit modules based on the netlist and the group setting information;
a distance calculating unit that calculates a distance satisfying a timing constraint between the set groups; and
a floorplan creation information generating unit that generates floorplan creation information for creating a floorplan including the calculated distance between the groups.

20. A floorplan optimizing method comprising:
storing a netlist including connection information of a plurality of circuit modules and group setting information for setting a group to the plurality of circuit modules to a storage unit;
setting the group to the plurality of circuit modules based on the netlist and the group setting information;
calculating a distance that satisfies a timing constraint between the set groups;
generating floorplan creation information for creating a floorplan including the calculated distance between the groups; and
creating floorplan information based on the netlist, the group setting information, and the floorplan creation information, the floorplan information being the floorplan of the group.

21. A non-transitory computer readable medium storing a floorplan optimizing program that causes a computer to execute a floorplan optimizing method, the floorplan optimizing method comprising:
storing a netlist including connection information of a plurality of circuit modules and group setting information for setting a group to the plurality of circuit modules to a storage unit;
setting the group to the plurality of circuit modules based on the netlist and the group setting information;
calculating a distance that satisfies a timing constraint between the set groups;
generating floorplan creation information for creating a floorplan including the calculated distance between the groups; and
creating floorplan information based on the netlist, the group setting information, and the floorplan creation information, the floorplan information being the floorplan of the group.

22. A floorplan optimizing device comprising:
a storage unit that stores a netlist including connection information of a plurality of circuit modules and group setting information for setting a group to the plurality of circuit modules:
a group setting unit that sets the group to the plurality of circuit modules based on the netlist and the group setting information;
a distance calculating unit that calculates a distance satisfying a timing constraint between the set groups;
a floorplan creation information generating unit that generates floorplan creation information for creating a floorplan including the calculated distance between the groups; and
a floorplan creating unit that creates floorplan information based on the netlist, the group setting information, and the floorplan creation information, the floorplan information being the floorplan of the group.
